(19) United States
(12) Patent Application Publication
(10) Pub. No.: US 2026/0285737 A1
(43) Pub. Date: Sep. 24, 2026

(54) GLASS AND METHODS OF MAKING THE SAME

(71) Applicant: CORNING INCORPORATED, CORNING, NY (US)

(72) Inventors: Timothy Michael Gross, Painted Post, NY (US); Alexandra Lai Ching Kao Andrews Mitchell, Ithaca, NY (US); Wendell Porter Weeks, JR., Rochester, NY (US)

(21) Appl. No.: 19/573,295

(22) Filed: Mar. 20, 2026

Related U.S. Application Data
(60) Provisional application No. 63/775,049, filed on Mar. 20, 2025.

(51) Int. Cl. C03C 3/062; C03C 3/097

(52) U.S. Cl. CPC C03C 3/062; C03C 3/097

(57) ABSTRACT

A glass, in terms of mol % of representative oxides, comprises silica in an amount greater than 20 mol % and less than 60 mol %, alumina in an amount greater than 15 mol % and less than 40 mol %, magnesia in an amount greater than 0.02 mol % and less than 20 mol %, lithia in an amount greater than 7 mol % and less than 25 mol %, soda in an amount greater than 0.02 mol % and less than 15 mol %, and yttria in an amount greater than 4 mol % and less than 20 mol %, where the glass has useful properties, such as scratch resistance and temperability. The glass may be formed and quenched such that the glass has fewer than 0.02 wt % crystals therein.

### CROSS-REFERENCE TO RELATED APPLICATIONS

This application claims the benefit of priority of U.S. Application Ser. No. 63/775,049 filed on Mar. 20, 2025, the content of which is relied upon and incorporated herein by reference in its entirety.

### BACKGROUND

The present application generally relates to glass and, in particular, to glasses having improved mechanical properties, such as greater modulus of elasticity, scratch resistance, temperability, or other properties.

Glass articles, such as cover glasses, glass backplanes, housings, and the like, are employed in both consumer and commercial electronic devices, such as smart phones, smart watches, and tablets. The mobile nature of these portable devices makes the devices and the glass articles included therein particularly vulnerable to accidental drops on hard surfaces, such as the ground. Moreover, glass articles, such as cover glasses, may include “touch” functionality, which necessitates that the glass article be contacted by various objects including a user's fingers and/or stylus devices. The glass articles, therefore, must be sufficiently robust to endure accidental dropping and regular contact without damage, such as scratching. Additionally, when dropped, the glass article may forcefully fragment, causing damage and negatively impacting the functionality of the device.

Accordingly, a need exists for alternative glasses well suited for use in such consumer products.

### SUMMARY

Applicants discovered a glass, in terms of mol % of representative oxides, that comprises silica in an amount greater than 20 mol % and less than 60 mol %, alumina in an amount greater than 15 mol % and less than 40 mol %, magnesia in an amount greater than 0.02 mol % and less than 20 mol %, lithia in an amount greater than 7 mol % and less than 25 mol %, soda in an amount greater than 0.02 mol % and less than 15 mol %, and yttria in an amount greater than 4 mol % and less than 20 mol %, where the glass has useful properties, such as scratch resistance and temperability. The glass be prone to devitrify, but may be formed and quenched such that the glass has fewer than 0.02 wt % crystals therein. The glass may be formed to be transparent and have a high modulus of elasticity and scratch resistance. Further the glass may be well suited for tempering.

### BRIEF DESCRIPTION OF THE DRAWINGS

FIG. 1 is a plan view of an electronic device incorporating any of the glass articles according to one or more embodiments described herein.

FIGS. 2-8 are digital images of glass articles according to aspects of the present disclosure.

FIGS. 9-10 are digital images of glass articles according to other aspects of the present disclosure.

### DETAILED DESCRIPTION

Reference will now be made in detail to various embodiments of glass compositions and glass articles formed therefrom having improved mechanical durability. Various embodiments of glass compositions and glass articles formed therefrom will be described herein with specific reference to the appended drawings.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the phrase “at least one of” does not modify each of the constituents or components in a list immediately following thereafter. For example, a recitation “at least one of A, B, and C,” does not mean “at least one of A, at least one of B, and at least one of C.” Instead, this recitation indicates selection of at least one from a group including A, B, and C.

In the embodiments of the glass composition and the resultant glass article described herein, the concentrations of constituent components (e.g., silica (SiO₂), alumina (Al₂O₃), and the like) are specified in mole percent (mol %) on a representative oxide basis, unless otherwise specified. A total sum of concentrations of oxide components in the glass composition and the resultant glass article is equal to 100 mol %. That said, glass compositions as disclosed herein may be measured and characterized in terms of such representative oxides, regardless of whether different compounds are used as raw materials, such as boric acid (B(OH)₃) or borax (Na₂H₂₀B₄O₁₇) raw materials to contribute boron as opposed to boria (B₂O₃) for example.

The term “free” when used to describe the concentration and/or absence of a particular constituent component in a glass composition and the resultant glass article, means that the constituent component is absent from the glass composition and the resultant glass article to a reasonable degree. However, the glass composition and the resultant glass article may contain traces of the constituent component as a contaminant or tramp for example, such as in amounts of less than 0.02 weight percent (wt %). As noted herein, the remainder of the application specifies the concentrations of constituent component in mol %. The contaminant or tramp amounts of the constituent components are listed in wt % for manufacturing purposes and one skilled in the art would understand the contaminant and tramp amounts being listed in wt %.

Density, as described herein, is measured by the buoyancy method of ASTM C693-93.

Refractive index, as described herein, is measured in accordance with ASTM E1967.

Stress optical coefficient (SOC), as described herein, is measured according to Procedure C (Glass Disc Method) described in ASTM standard C770-16, entitled “Standard Test Method for Measurement of Glass Stress-Optical Coefficient,” the contents of which are incorporated herein by reference in their entirety.

Young's modulus, as described herein, is provided in units of gigapascals (GPa) and is measured using resonant ultrasound spectroscopy in accordance with ASTM C623, unless otherwise indicated.

Shear modulus, as described herein, is provided in units of gigapascals (GPa). The shear modulus of the glass composition is measured in accordance with ASTM C623, unless otherwise indicated.

Poisson's ratio, as described herein, is measured in accordance with ASTM C623, unless otherwise indicated.

The term “liquidus temperature,” as described herein, refers to the temperature at which the glass composition begins to devitrify as determined with the gradient furnace method according to ASTM C829-81.

The term “strain point,” as described herein, refers to the temperature at which the viscosity of the glass composition is 1×10^{14.68} poise as measured in accordance with ASTM C598.

The terms “anneal point” or “effective annealing temperature,” as described herein, refer to the temperature at which the viscosity of the glass composition is 1×10^{13.18} poise as measured in accordance with ASTM C598.

The term “softening point,” as described herein, refers to the temperature at which the viscosity of the glass composition is 1×10^{7.6} poise as measured in accordance with ASTM C598.

The term “linear coefficient of thermal expansion” or “CTE,” as described herein, is measured in accordance with ASTM E228-85 over the temperature range of 0° C. to 300° C. and is expressed in terms of “×10⁻⁷/° C.” as an average over the temperature range.

Fracture toughness (K_{1C}) represents the ability of a glass composition to resist fracture. Fracture toughness is measured on a non-strengthened glass article, such as measuring the K_{1C} value prior to ion exchange treatment of the glass article, thereby representing a feature of a glass article prior to ion exchange. The fracture toughness test methods described herein are not suitable for glasses that have been exposed to ion exchange treatment. But, fracture toughness measurements performed as described herein on the same glass article prior to ion exchange treatment correlate to fracture toughness after ion exchange treatment, and are accordingly used as such. The chevron notched short bar (CNSB) method utilized to measure the K_{1C} value is disclosed in Reddy, K. P. R. et al, “Fracture Toughness Measurement of Glass and Ceramic Materials Using Chevron-Notched Specimens,” J. Am. Ceram. Soc., 71 [6], C-310-C-313 (1988) except that Y*ₘ is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992). Unless otherwise specified, all fracture toughness values were measured by chevron notched short bar (CNSB) method.

Vickers hardness, as described herein, is measured according to ASTM E384.

The fracture toughness, scratch resistance, and frangibility of a glass article are generally controlled by the Young's modulus of the glass. For example, for ion exchangeable glasses, a relatively high Young's modulus may be advantageous because it increases the frangibility limit, allowing for more stress to be imparted before the glass becomes frangibility. Ion exchange may not be necessary if the glass achieves a desirably high Young's modulus. Therefore, both ion exchangeable and non-ion-exchangeable glass compositions may be used to achieve a glass article having a relatively high Young's modulus.

High field strength oxides such as yttria (Y₂O₃) and magnesia (MgO) may be added to increase the Young's modulus of the glass. However, such oxides are generally highly refractory and, thus, additions of these oxides may increase the liquidus temperatures of the glass composition beyond those suitable for conventional glass manufacturing. Thus, alternative manufacturing methods may be considered such that glass compositions having a relatively high liquidus temperature may be manufactured to form glass articles having a relatively high Young's modulus.

Disclosed herein are glass compositions and resultant glass articles useful to solve the aforementioned problems. Specifically, the glass compositions and the resultant glass articles disclosed herein comprise a relatively high concentration of yttria (e.g., greater than or equal to 5 mol %) in combination with magnesia (e.g., greater than or equal to 5 mol %), which at least in part results in glass compositions having improved Young's modulus (e.g., greater than or equal to 100 GPa). In view of the relatively high liquidus temperatures (e.g., greater than or equal to 1200° C.) of the glass compositions disclosed herein, manufacturing methods that rapidly quench the glass composition (e.g., cooling rate greater than 50° C./s) to reduce or avoid crystallization, such as gob pressing, may be used to form glass articles from the glass compositions.

The glass compositions and the resultant glass articles described herein may be described as aluminosilicate glass compositions and articles and comprise silica and alumina. The glass compositions and the resultant glass articles described herein also include yttria in combination with magnesia and optionally include zirconia (ZrO₂), niobium pentoxide (Nb₂O₅), and/or tantalum pentoxide (Ta₂O₅) to increase Young's modulus. The glass compositions and the resultant glass articles described herein may also include alkali oxides, such as lithia (Li₂O) and soda (Na₂O), to enable the ion exchangeability of the glass compositions.

Silica is the primary glass former in the glass compositions described herein and may function to stabilize the network structure of the resultant glass articles. The concentration of silica in the glass composition and the resultant glass article should be sufficiently high (e.g., greater than or equal to 20 mol %) to provide basic glass forming capability. In embodiments, the amount of silica may be limited (e.g., less than or equal to 60 mol %) to control the softening point of the glass composition and, thus, may aid in improving the meltability and the formability of the resulting glass article.

Accordingly, in embodiments, the glass composition and the resultant glass article may comprise greater than or equal to 20 mol % and less than or equal 60 mol % silica. In embodiments, the glass composition and the resultant glass article may comprise greater than or equal to 25 mol % and less than or equal to 55 mol % silica. In embodiments, the concentration of silica in the glass composition and the resultant glass article may be greater than or equal to 20 mol %, greater than or equal to 25 mol %, greater than or equal to 30 mol %, greater than or equal to 35 mol %, or even greater than or equal to 40 mol %. In embodiments, the concentration of silica in the glass composition and the resultant glass article may be less than or equal to 60 mol %, less than or equal to 57 mol %, less than or equal to 55 mol %, less than or equal to 53 mol %, or even less than or equal to 50 mol %. In embodiments, the concentration of silica in the glass composition and the resultant glass article may be greater than or equal to 20 mol % and less than or equal to 60 mol %, greater than or equal to 20 mol % and less than or equal to 57 mol %, greater than or equal to 20 mol % and less than or equal to 55 mol %, greater than or equal to 20 mol % and less than or equal to 53 mol %, greater than or equal to 20 mol % and less than or equal to 50 mol %, greater than or equal to 25 mol % and less than or equal to 60 mol %, greater than or equal to 25 mol % and less than or equal to 57 mol %, greater than or equal to 25 mol % and less than or equal to 55 mol %, greater than or equal to 25 mol % and less than or equal to 53 mol %, greater than or equal to 25 mol % and less than or equal to 50 mol %, greater than or equal to 30 mol % and less than or equal to 60 mol %, greater than or equal to 30 mol % and less than or equal to 57 mol %, greater than or equal to 30 mol % and less than or equal to 55 mol %, greater than or equal to 30 mol % and less than or equal to 53 mol %, greater than or equal to 30 mol % and less than or equal to 50 mol %, greater than or equal to 35 mol % and less than or equal to 60 mol %, greater than or equal to 35 mol % and less than or equal to 57 mol %, greater than or equal to 35 mol % and less than or equal to 55 mol %, greater than or equal to 35 mol % and less than or equal to 53 mol %, greater than or equal to 35 mol % and less than or equal to 50 mol %, greater than or equal to 40 mol % and less than or equal to 60 mol %, greater than or equal to 40 mol % and less than or equal to 57 mol %, greater than or equal to 40 mol % and less than or equal to 55 mol %, greater than or equal to 40 mol % and less than or equal to 53 mol %, or even greater than or equal to 40 mol % and less than or equal to 50 mol %, or any and all sub-ranges formed from any of these endpoints.

Like silica, alumina may also stabilize the glass network and additionally provide improved mechanical properties, such as Young's modulus, and chemical durability to the resulting glass article. The amount of alumina may also be tailored to the control the viscosity of the glass composition. The concentration of alumina should be sufficiently high (e.g., greater than or equal to 15 mol %) such that the glass composition and the resultant glass article have the desired Young's modulus (e.g., greater than or equal to 100 GPa). If the amount of alumina is too high (e.g., greater than 40 mol %), the viscosity of the melt may increase, thereby diminishing the formability of the glass composition. In embodiments, the glass composition and the resultant glass article may comprise greater than or equal to 15 mol % and less than or equal to 40 mol % alumina. In embodiments, the glass composition and the resultant glass article may comprise greater than or equal to 17 mol % and less than or equal to 35 mol % alumina. In embodiments, the concentration of alumina in the glass composition and the resultant glass article may be greater than or equal to 15 mol %, greater than or equal to 17 mol %, greater than or equal to 19 mol %, greater than or equal to 21 mol %, greater than or equal to 23 mol %, or even greater than or equal to 25 mol %. In embodiments, the concentration of alumina in the glass composition and the resultant glass article may be less than or equal to 40 mol %, less than or equal to 37 mol %, less than or equal to 35 mol %, less than or equal to 33 mol %, less than or equal to 30 mol %, or even less than or equal to 27 mol %. In embodiments, the concentration of alumina in the glass composition and the resultant glass article may be greater than or equal to 15 mol % and less than or equal to 40 mol %, greater than or equal to 15 mol % and less than or equal to 37 mol %, greater than or equal to 15 mol % and less than or equal to 35 mol %, greater than or equal to 15 mol % and less than or equal to 33 mol %, greater than or equal to 15 mol % and less than or equal to 30 mol %, greater than or equal to 15 mol % and less than or equal to 27 mol %, greater than or equal to 17 mol % and less than or equal to 40 mol %, greater than or equal to 17 mol % and less than or equal to 37 mol %, greater than or equal to 17 mol % and less than or equal to 35 mol %, greater than or equal to 17 mol % and less than or equal to 33 mol %, greater than or equal to 17 mol % and less than or equal to 30 mol %, greater than or equal to 17 mol % and less than or equal to 27 mol %, greater than or equal to 19 mol % and less than or equal to 40 mol %, greater than or equal to 19 mol % and less than or equal to 37 mol %, greater than or equal to 19 mol % and less than or equal to 35 mol %, greater than or equal to 19 mol % and less than or equal to 33 mol %, greater than or equal to 19 mol % and less than or equal to 30 mol %, greater than or equal to 19 mol % and less than or equal to 27 mol %, greater than or equal to 21 mol % and less than or equal to 40 mol %, greater than or equal to 21 mol % and less than or equal to 37 mol %, greater than or equal to 21 mol % and less than or equal to 35 mol %, greater than or equal to 21 mol % and less than or equal to 33 mol %, greater than or equal to 21 mol % and less than or equal to 30 mol %, greater than or equal to 21 mol % and less than or equal to 27 mol %, greater than or equal to 23 mol % and less than or equal to 40 mol %, greater than or equal to 23 mol % and less than or equal to 37 mol %, greater than or equal to 23 mol % and less than or equal to 35 mol %, greater than or equal to 23 mol % and less than or equal to 33 mol %, greater than or equal to 23 mol % and less than or equal to 30 mol %, greater than or equal to 23 mol % and less than or equal to 27 mol %, greater than or equal to 25 mol % and less than or equal to 40 mol %, greater than or equal to 25 mol % and less than or equal to 37 mol %, greater than or equal to 25 mol % and less than or equal to 35 mol %, greater than or equal to 25 mol % and less than or equal to 33 mol %, greater than or equal to 25 mol % and less than or equal to 30 mol %, or even greater than or equal to 25 mol % and less than or equal to 27 mol %, or any and all sub-ranges formed from any of these endpoints.

As noted hereinabove, yttria and magnesia may increase the Young's modulus of the glass compositions and the resultant glass articles described herein.

In embodiments, the glass composition and the resultant glass article may comprise greater than or equal to 4 mol % and less than or equal to 30 mol % yttria. In embodiments, the glass composition and the resultant glass article may comprise greater than or equal to 5 mol % and less than or equal to 28 mol % yttria. In embodiments, the concentration of yttria in the glass composition and the resultant glass article may be greater than or equal to 8 mol %, greater than or equal to 8.5 mol %, greater than or equal to 9 mol %, or even greater than or equal to 9.5 mol %. In embodiments, the concentration of yttria in the glass composition and the resultant glass article may be less than or equal to 20 mol %, less than or equal to 19 mol %, less than or equal to 18 mol %, less than or equal to 17 mol %, or even less than or equal to 16 mol %. In embodiments, the concentration of yttria in the glass composition and the resultant glass article may be greater than or equal to 4 mol % and less than or equal to 20 mol %, greater than or equal to 4 mol % and less than or equal to 19 mol %, greater than or equal to 4 mol % and less than or equal to 18 mol %, greater than or equal to 4 mol % and less than or equal to 17 mol %, greater than or equal to 4 mol % and less than or equal to 16 mol %, greater than or equal to 5 mol % and less than or equal to 20 mol %, greater than or equal to 5 mol % and less than or equal to 19 mol %, greater than or equal to 5 mol % and less than or equal to 18 mol %, greater than or equal to 5 mol % and less than or equal to 17 mol %, greater than or equal to 5 mol % and less than or equal to 16 mol %, greater than or equal to 8 mol % and less than or equal to 20 mol %, greater than or equal to 8 mol % and less than or equal to 19 mol %, greater than or equal to 8 mol % and less than or equal to 18 mol %, greater than or equal to 8 mol % and less than or equal to 17 mol %, greater than or equal to 8 mol % and less than or equal to 16 mol %, greater than or equal to 8.5 mol % and less than or equal to 20 mol %, greater than or equal to 8.5 mol % and less than or equal to 19 mol %, greater than or equal to 8.5 mol % and less than or equal to 18 mol %, greater than or equal to 8.5 mol % and less than or equal to 17 mol %, or even greater than or equal to 8.5 mol % and less than or equal to 16 mol %, greater than or equal to 9 mol % and less than or equal to 20 mol %, greater than or equal to 9 mol % and less than or equal to 19 mol %, greater than or equal to 9 mol % and less than or equal to 18 mol %, greater than or equal to 9 mol % and less than or equal to 17 mol %, or even greater than or equal to 9 mol % and less than or equal to 16 mol %, greater than or equal to 9.5 mol % and less than or equal to 20 mol %, greater than or equal to 9.5 mol % and less than or equal to 19 mol %, greater than or equal to 9.5 mol % and less than or equal to 18 mol %, greater than or equal to 9.5 mol % and less than or equal to 17 mol %, or even greater than or equal to 9.5 mol % and less than or equal to 16 mol %, greater than or equal to 10 mol % and less than or equal to 20 mol %, greater than or equal to 10 mol % and less than or equal to 19 mol %, greater than or equal to 10 mol % and less than or equal to 18 mol %, greater than or equal to 10 mol % and less than or equal to 17 mol %, or even greater than or equal to 10 mol % and less than or equal to 16 mol %, or any and all sub-ranges formed from any of these endpoints.

In embodiments, the glass composition and the resultant glass article may comprise greater than or equal to 0.02 mol % and less than 30 mol % magnesia. In magnesia embodiments, the glass composition and the resultant glass article may comprise greater than or equal to 0.05 mol % and less than or equal to 25 mol % magnesia. In embodiments, the concentration of magnesia in the glass composition and the resultant glass article may be greater than or equal to 0.05 mol %, greater than or equal to 0.1 mol %, greater than or equal to 0.5 mol %, greater than or equal to 1 mol %, greater than or equal to 2 mol %, greater than or equal to 4 mol %, or greater than or equal to 6 mol %. In embodiments, the concentration of magnesia in the glass composition and the resultant glass article may be less than 30 mol %, less than or equal to 25 mol %, less than or equal to 20 mol %, less than or equal to 15 mol %, less than or equal to 12 mol %, less than or equal to 10 mol %, or even less than or equal to 9 mol %. In embodiments, the concentration of magnesia in the glass composition and the resultant glass article may be greater than or equal to 0.05 mol % and less than 30 mol %, greater than or equal to 0.05 mol % and less than or equal to 20 mol %, greater than or equal to 0.05 mol % and less than or equal to 15 mol %, greater than or equal to 0.05 mol % and less than or equal to 10 mol %, greater than or equal to 2 mol % and less than 30 mol %, greater than or equal to 2 mol % and less than or equal to 20 mol %, greater than or equal to 2 mol % and less than or equal to 15 mol %, greater than or equal to 2 mol % and less than or equal to 10 mol %, greater than or equal to 4 mol % and less than 30 mol %, greater than or equal to 4 mol % and less than or equal to 20 mol %, greater than or equal to 4 mol % and less than or equal to 15 mol %, greater than or equal to 4 mol % and less than or equal to 10 mol %, greater than or equal to 6 mol % and less than or equal to 30 mol %, greater than or equal to 6 mol % and less than or equal to 20 mol %, greater than or equal to 6 mol % and less than or equal to 15 mol %, greater than or equal to 6 mol % and less than or equal to 10 mol %, or any and all sub-ranges formed from any of these endpoints.

As noted hereinabove, the glass compositions and the resultant glass articles described herein may include zirconia, niobium pentoxide, and/or tantalum pentoxide, which increase the Young's modulus of the glass compositions and the resultant glass articles described herein.

In embodiments, the glass composition and the resultant glass article may comprise greater than or equal to 0.1 mol % and less than or equal to 25 mol % zirconia. In embodiments, the concentration of zirconia in the glass composition and the resultant glass article may be greater than or equal to 0 mol %, greater than or equal to 0.1 mol %, greater than or equal to 0.5 mol %, greater than or equal to 1 mol %, greater than or equal to 2 mol %, greater than or equal to 3 mol %, greater than or equal to 4 mol %, or even greater than or equal to 5 mol %. In embodiments, the concentration of zirconia in the glass composition and the resultant glass article may be less than or equal to 25 mol %, less than or equal to 20 mol %, less than or equal to 15 mol %, less than or equal to 12 mol %, less than or equal to 10 mol %, less than or equal to 8 mol %, less than or equal to 6 mol %, or even less than or equal to 4 mol %. In embodiments, the concentration of zirconia in the glass composition and the resultant glass article may be greater than or equal to 0 mol % and less than or equal to 25 mol %, greater than or equal to 0 mol % and less than or equal to 20 mol %, greater than or equal to 0 mol % and less than or equal to 15 mol %, greater than or equal to 0 mol % and less than or equal to 12 mol %, greater than or equal to 0 mol % and less than or equal to 10 mol %, greater than or equal to 0 mol % and less than or equal to 8 mol %, greater than or equal to 0 mol % and less than or equal to 6 mol %, greater than or equal to 0 mol % and less than or equal to 4 mol %, greater than or equal to 0.1 mol % and less than or equal to 25 mol %, greater than or equal to 0.1 mol % and less than or equal to 20 mol %, greater than or equal to 0.1 mol % and less than or equal to 15 mol %, greater than or equal to 0.1 mol % and less than or equal to 12 mol %, greater than or equal to 0.1 mol % and less than or equal to 10 mol %, greater than or equal to 0.1 mol % and less than or equal to 8 mol %, greater than or equal to 0.1 mol % and less than or equal to 6 mol %, greater than or equal to 0.1 mol % and less than or equal to 4 mol %, or any and all sub-ranges formed from any of these endpoints. In embodiments, the glass composition and the resultant glass article may be free of zirconia.

In embodiments, the glass composition and the resultant glass article may comprise greater than or equal to 0.5 mol % and less than or equal to 25 mol % niobium pentoxide. In embodiments, the concentration of niobium pentoxide in the glass composition and the resultant glass article may be greater than or equal to 0 mol %, greater than or equal to 0.5 mol %, greater than or equal to 1 mol %, greater than or equal to 3 mol %, greater than or equal to 5 mol %, or even greater than or equal to 7 mol %. In embodiments, the concentration of niobium pentoxide in the glass composition and the resultant glass article may be less than or equal to 25 mol %, less than or equal to 20 mol %, less than or equal to 15 mol %, less than or equal to 13 mol %, less than or equal to 11 mol %, less than or equal to 9 mol %, less than or equal to 7 mol %, or even less than or equal to 5 mol %. In embodiments, the concentration of niobium pentoxide in the glass composition and the resultant glass article may be greater than or equal to 0 mol % and less than or equal to 25 mol %, greater than or equal to 0 mol % and less than or equal to 20 mol %, greater than or equal to 0 mol % and less than or equal to 15 mol %, greater than or equal to 0 mol % and less than or equal to 13 mol %, greater than or equal to 0 mol % and less than or equal to 11 mol %, greater than or equal to 0 mol % and less than or equal to 9 mol %, greater than or equal to 0 mol % and less than or equal to 7 mol %, greater than or equal to 0 mol % and less than or equal to 5 mol %, greater than or equal to 0.5 mol % and less than or equal to 25 mol %, greater than or equal to 0.5 mol % and less than or equal to 20 mol %, greater than or equal to 0.5 mol % and less than or equal to 15 mol %, greater than or equal to 0.5 mol % and less than or equal to 13 mol %, greater than or equal to 0.5 mol % and less than or equal to 11 mol %, greater than or equal to 0.5 mol % and less than or equal to 9 mol %, greater than or equal to 0.5 mol % and less than or equal to 7 mol %, greater than or equal to 0.5 mol % and less than or equal to 5 mol %, or any and all sub-ranges formed from any of these endpoints. In embodiments, the glass composition and the resultant glass article may be free of niobium pentoxide.

In embodiments, the glass composition and the resultant glass article may comprise greater than or equal to 0.5 mol % and less than or equal to 25 mol % tantalum pentoxide. In embodiments, the concentration of tantalum pentoxide in the glass composition and the resultant glass article may be greater than or equal to 0 mol %, greater than or equal to 0.5 mol %, greater than or equal to 1 mol %, or even greater than or equal to 2 mol. In embodiments, the concentration of tantalum pentoxide in the glass composition and the resultant glass article may be less than or equal to 25 mol %, less than or equal to 20 mol %, less than or equal to 15 mol %, less than or equal to 10 mol %, less than or equal to 7 mol %, or even less than or equal to 5 mol. In embodiments, the concentration of tantalum pentoxide in the glass composition and the resultant glass article may be greater than or equal to 0 mol % and less than or equal to 25 mol %, greater than or equal to 0 mol % and less than or equal to 20 mol %, greater than or equal to 0 mol % and less than or equal to 15 mol %, greater than or equal to 0 mol % and less than or equal to 10 mol %, greater than or equal to 0 mol % and less than or equal to 7 mol %, greater than or equal to 0 mol % and less than or equal to 5 mol %, greater than or equal to 0.5 mol % and less than or equal to 25 mol %, greater than or equal to 0.5 mol % and less than or equal to 20 mol %, greater than or equal to 0.5 mol % and less than or equal to 15 mol %, greater than or equal to 0.5 mol % and less than or equal to 10 mol %, greater than or equal to 0.5 mol % and less than or equal to 7 mol %, greater than or equal to 0.5 mol % and less than or equal to 5 mol %, or any and all sub-ranges formed from any of these endpoints. In embodiments, the glass composition and the resultant glass article may be free of tantalum pentoxide.

In embodiments, the glass composition and the resultant glass article may comprise a total concentration or sum of yttria, magnesia, zirconia, and niobium pentoxide (i.e., yttria (mol %) plus magnesia (mol %) plus zirconia (mol %) plus niobium pentoxide (mol %)) greater than or equal to 12.5 mol % and less than or equal to 45 mol %. In embodiments, yttria plus magnesia plus zirconia plus niobium pentoxide plus tantalum pentoxide in the glass composition and the resultant glass article may be greater than or equal to 12.5 mol %, greater than or equal to 14 mol %, greater than or equal to 16 mol %, greater than or equal to 18 mol %, or even greater than or equal to 20 mol %. In embodiments, yttria plus magnesia plus zirconia plus niobium pentoxide plus tantalum pentoxide in the glass composition and the resultant glass article may be less than or equal to 45 mol %, less than or equal to 40 mol %, less than or equal to 35 mol %, less than or equal to 30 mol %, or even less than or equal to 25 mol %. In embodiments, yttria plus magnesia plus zirconia plus niobium pentoxide plus tantalum pentoxide in the glass composition and the resultant glass article may be greater than or equal to 12.5 mol % and less than or equal to 45 mol %, greater than or equal to 12.5 mol % and less than or equal to 40 mol %, greater than or equal to 12.5 mol % and less than or equal to 35 mol %, greater than or equal to 12.5 mol % and less than or equal to 30 mol %, greater than or equal to 12.5 mol % and less than or equal to 25 mol %, greater than or equal to 14 mol % and less than or equal to 45 mol %, greater than or equal to 14 mol % and less than or equal to 40 mol %, greater than or equal to 14 mol % and less than or equal to 35 mol %, greater than or equal to 14 mol % and less than or equal to 30 mol %, greater than or equal to 14 mol % and less than or equal to 25 mol %, greater than or equal to 16 mol % and less than or equal to 45 mol %, greater than or equal to 16 mol % and less than or equal to 40 mol %, greater than or equal to 16 mol % and less than or equal to 35 mol %, greater than or equal to 16 mol % and less than or equal to 30 mol %, greater than or equal to 16 mol % and less than or equal to 25 mol %, greater than or equal to 18 mol % and less than or equal to 45 mol %, greater than or equal to 18 mol % and less than or equal to 40 mol %, greater than or equal to 18 mol % and less than or equal to 35 mol %, greater than or equal to 18 mol % and less than or equal to 30 mol %, greater than or equal to 18 mol % and less than or equal to 25 mol %, greater than or equal to 20 mol % and less than or equal to 45 mol %, greater than or equal to 20 mol % and less than or equal to 40 mol %, greater than or equal to 20 mol % and less than or equal to 35 mol %, greater than or equal to 20 mol % and less than or equal to 30 mol %, or even greater than or equal to 20 mol % and less than or equal to 25 mol %, or any and all sub-ranges formed from any of these endpoints.

The glass compositions and the resultant glass articles may contain alkali oxides, such as lithia and soda, to enable the ion exchangeability of the resultant glass article. Lithia also reduces the softening point of the glass composition, thereby increasing the formability of the glass. In embodiments, the glass composition and the resultant glass article may comprise greater than or equal to 1 mol % and less than or equal to 25 mol % lithia. In embodiments, the concentration of lithia in the glass composition and the resultant glass article may be greater than or equal to 0 mol %, greater than or equal to 0.5 mol %, greater than or equal to 1 mol %, greater than or equal to 5 mol %, greater than or equal to 7 mol %, or even greater than or equal to 10 mol %. In embodiments, the concentration of lithia in the glass composition and the resultant glass article may be less than or equal to 25 mol %, less than or equal to 20 mol %, less than or equal to 18 mol %. In embodiments, the concentration of lithia in the glass composition and the resultant glass article may be greater than or equal to 0.02 mol % and less than or equal to 25 mol %, greater than or equal to 0.02 mol % and less than or equal to 20 mol %, greater than or equal to 7 mol % and less than or equal to 25 mol %, greater than or equal to 7 mol % and less than or equal to 20 mol %, greater than or equal to 7 mol % and less than or equal to 18 mol %, or any and all sub-ranges formed from these endpoints. In embodiments, the glass composition may be free of lithia.

In addition to aiding in ion exchangeability of the glass composition, soda decreases the softening point and improves formability of the glass composition. However, if too much soda is added to the glass composition, the softening point may be too low. In embodiments, the glass composition and the resultant glass article may comprise greater than 0 mol % and less than or equal to 10 mol % soda. In embodiments, the concentration of soda in the glass composition and the resultant glass article may be greater than or equal to 0 mol %, greater than or equal to 0.05 mol %, or even greater than or equal to 0.1 mol %. In embodiments, the concentration of soda in the glass composition and the resultant glass article may be less than or equal to 10 mol %, less than or equal to 6 mol %, less than or equal to 5 mol %. In embodiments, the concentration of soda in the glass composition and the resultant glass article may be greater than or equal to 0.02 mol % and less than or equal to 10 mol %, greater than or equal to 0.02 mol % and less than or equal to 6 mol %, greater than or equal to 0.02 mol % and less than or equal to 5 mol %, greater than or equal to 0.02 mol % and less than or equal to 4 mol %, greater than or equal to 0.1 mol % and less than or equal to 10 mol %, greater than or equal to 0.1 mol % and less than or equal to 5 mol %, greater than or equal to 0.1 mol % and less than or equal to 3 mol %, or even greater than or equal to 0.1 mol % and less than or equal to 1 mol %, or any and all sub-ranges formed from any of these endpoints. In embodiments, the glass composition may be free of soda.

The glass compositions and the resultant glass articles described herein may include other divalent oxides in addition to magnesia, such as lime (CaO). Lime may decrease the liquidus temperature of the glass composition. In embodiments, the glass composition and the resultant glass article may comprise greater than 0 mol % and less than or equal to 30 mol % lime. In embodiments, the concentration of lime in the glass composition and the resultant glass article may be greater than or equal to 0 mol %, greater than or equal to 0.05 mol %, greater than or equal to 0.1 mol %, greater than or equal to 0.5 mol %, or even greater than or equal to 1 mol %. In embodiments, the concentration of lime in the glass composition and the resultant glass article may be less than or equal to 30 mol %, less than or equal to 25 mol %, less than or equal to 20 mol %, less than or equal to 15 mol %, or even less than or equal to 5 mol %. In embodiments, the concentration of lime in the glass composition and the resultant glass article may be greater than or equal to 0 mol % and less than or equal to 20 mol %, greater than or equal to 0 mol % and less than or equal to 15 mol %, greater than or equal to 0 mol % and less than or equal to 10 mol %, greater than or equal to 0 mol % and less than or equal to 5 mol %, greater than or equal to 0 mol % and less than or equal to 1 mol %, greater than or equal to 0.05 mol % and less than or equal to 20 mol %, greater than or equal to 0.05 mol % and less than or equal to 15 mol %, greater than or equal to 0.05 mol % and less than or equal to 10 mol %, greater than or equal to 0.05 mol % and less than or equal to 5 mol %, greater than or equal to 0.05 mol % and less than or equal to 1 mol %, or any and all sub-ranges formed from any of these endpoints. In embodiments, the glass composition and the resultant glass article may be free of lime.

The glass compositions and the resultant glass articles described herein may include boria (B₂O₃). Boria may decrease the liquidus temperature of the glass composition. In embodiments, the glass composition and the resultant glass article may comprise greater than or equal to 0.1 mol % and less than or equal to 30 mol % boria. In embodiments, the concentration of boria in the glass composition and the resultant glass article may be greater than or equal to 0 mol %, greater than or equal to 0.1 mol %, greater than or equal to 0.5 mol %, or even greater than or equal to 1 mol %. In embodiments, the concentration of boria in the glass composition and the resultant glass article may be less than or equal to 30 mol %, less than or equal to 20 mol %, less than or equal to 10 mol %, or even less than or equal to 2 mol %. In embodiments, the concentration of boria in the glass composition and the resultant glass article may be greater than or equal to 0 mol % and less than or equal to 30 mol %, greater than or equal to 0 mol % and less than or equal to 20 mol %, greater than or equal to 0 mol % and less than or equal to 10 mol %, greater than or equal to 0 mol % and less than or equal to 2 mol %, greater than or equal to 0.1 mol % and less than or equal to 30 mol %, greater than or equal to 0.1 mol % and less than or equal to 20 mol %, greater than or equal to 0.1 mol % and less than or equal to 10 mol %, greater than or equal to 0.1 mol % and less than or equal to 2 mol %, or any and all sub-ranges formed from any of these endpoints. In embodiments, the glass composition and the resultant glass article may be free of boria.

In embodiments, the glass composition may be free of titania (TiO₂). The glass composition may have less than 2 mol % titania, less than 0.2 mol % titania, such as less than 0.02 mol % titania for example. Titania may result in undesirable coloration and may also provide effective nucleation sites for undesirable crystallization to occur.

In embodiments, the glass compositions and the resultant glass article described herein may further include one or more fining agents. In embodiments, the fining agents may include, for example, stannic oxide (SnO₂). In embodiments, the concentration of stannic oxide in the glass composition and the resultant glass article may be greater than or equal to 0.05 mol % and less than or equal to 1 mol %, greater than or equal to 0.05 mol % and less than or equal to 0.5 mol %, greater than or equal to 0.05 mol % and less than or equal to 0.25 mol %, greater than or equal to 0.1 mol % and less than or equal to 1 mol %, greater than or equal to 0.1 mol % and less than or equal to 0.5 mol %, or even greater than or equal to 0.1 mol % and less than or equal to 0.25 mol %, or any and all sub-ranges formed from any of these endpoints. In embodiments, the glass composition and the resultant glass article may be free of stannic oxide.

In embodiments, the glass compositions and the resultant glass articles described herein may further include tramp materials such as iron oxide (Fe₂O₃, aka ferric oxide), ferrous oxide (FeO), MnO, MoO₃, CdO, As₂O₃, Sb₂O₃, sulfur-based compounds, such as sulfates, halogens, or combinations thereof.

The articles formed from the glass compositions described herein may be any suitable shape or thickness, which may vary depending on the particular application for use of the glass composition. Glass sheet embodiments may have a thickness greater than or equal to 30 μm, greater than or equal to 50 μm, greater than or equal to 100 μm, greater than or equal to 250 μm, greater than or equal to 500 μm, greater than or equal to 750 μm, or even greater than or equal to 1 mm. In embodiments, the glass sheet embodiments may have a thickness less than or equal to 6 mm, less than or equal to 5 mm, less than or equal to 4 mm, less than or equal to 3 mm, or even less than or equal to 2 mm. In embodiments, the glass sheet embodiments may have a thickness greater than or equal to 30 μm and less than or equal to 6 mm, greater than or equal to 30 μm and less than or equal to 5 mm, greater than or equal to 30 μm and less than or equal to 4 mm, greater than or equal to 30 μm and less than or equal to 3 mm, greater than or equal to 30 μm and less than or equal to 2 mm, greater than or equal to 50 μm and less than or equal to 6 mm, greater than or equal to 50 μm and less than or equal to 5 mm, greater than or equal to 50 μm and less than or equal to 4 mm, greater than or equal to 50 μm and less than or equal to 3 mm, greater than or equal to 50 μm and less than or equal to 2 mm, greater than or equal to 100 μm and less than or equal to 6 mm, greater than or equal to 100 μm and less than or equal to 5 mm, greater than or equal to 100 μm and less than or equal to 4 mm, greater than or equal to 100 μm and less than or equal to 3 mm, greater than or equal to 100 μm and less than or equal to 2 mm, greater than or equal to 250 μm and less than or equal to 6 mm, greater than or equal to 250 μm and less than or equal to 5 mm, greater than or equal to 250 μm and less than or equal to 4 mm, greater than or equal to 250 μm and less than or equal to 3 mm, greater than or equal to 250 μm and less than or equal to 2 mm, greater than or equal to 500 μm and less than or equal to 6 mm, greater than or equal to 500 μm and less than or equal to 5 mm, greater than or equal to 500 μm and less than or equal to 4 mm, greater than or equal to 500 μm and less than or equal to 3 mm, greater than or equal to 500 μm and less than or equal to 2 mm, greater than or equal to 750 μm and less than or equal to 6 mm, greater than or equal to 750 μm and less than or equal to 5 mm, greater than or equal to 750 μm and less than or equal to 4 mm, greater than or equal to 750 μm and less than or equal to 3 mm, greater than or equal to 750 μm and less than or equal to 2 mm, greater than or equal to 1 mm and less than or equal to 6 mm, greater than or equal to 1 mm and less than or equal to 5 mm, greater than or equal to 1 mm and less than or equal to 4 mm, greater than or equal to 1 mm and less than or equal to 3 mm, or even greater than or equal to 1 mm and less than or equal to 2 mm, or any and all sub-ranges formed from any of these endpoints.

As discussed hereinabove, the glass compositions and the resultant glass articles described herein may have increased Young's modulus such that the glass compositions and the resultant glass articles are more elastic. In embodiments, the glass composition and the resultant glass article may have a Young's modulus greater than or equal to 100 GPa, greater than or equal to 105 GPa, greater than or equal to 110 GPa, or even greater than or equal to 115 GPa. In embodiments, the glass composition and the resultant glass article may have a Young's modulus less than or equal to 150 GPa.

As discussed hereinabove, the glass compositions and the resultant glass articles described herein may have relatively high liquidus temperatures (e.g., greater than or equal to 1200° C.) due to the inclusion of high field strength oxides such as yttria and magnesia and optionally zirconia, niobium pentoxide, and/or tantalum pentoxide. In embodiments, the glass composition and the resultant glass article may comprise a liquidus temperature greater than or equal to 1200° C. In embodiments, may comprise a liquidus temperature greater than or equal to 1200° C., greater than or equal to 1250° C., greater than or equal to 1300° C., greater than or equal to 1350° C., greater than or equal to 1400° C., or even greater than or equal to 1450° C.

The glass compositions and the resultant glass articles described herein may comprise relatively high strain, anneal, and softening points, thereby allowing for high temperature, secondary processing steps, such as ion exchange and heat treatments to further improve mechanical properties (e.g., Young's modulus).

In embodiments, the glass composition and the resultant glass article may have a strain point greater than or equal to 600° C., greater than or equal to 650° C., or even greater than or equal to 700° C. In embodiments, the glass composition and the resultant glass article may have a strain point less than or equal to 950° C., less than or equal to 900° C., or even less than or equal to 850° C.

In embodiments, the glass composition and the resultant glass article may have an anneal point greater than or equal to 600° C., greater than or equal to 650° C., or even greater than or equal to 700° C. In embodiments, the glass composition and the resultant glass article may have an anneal point less than or equal to 1000° C., less than or equal to 950° C., or even less than or equal to 900° C.

In embodiments, the glass composition and the resultant glass article may have a softening point greater than or equal to 800° C., greater than or equal to 850° C., or even greater than or equal to 900° C. In embodiments, the glass composition and the resultant glass article may have a softening point less than or equal to 1150° C., less than or equal to 1100° C., or even less than or equal to 1050° C.

In embodiments, the glass composition and the resultant glass article may have a density greater than or equal to 2.8 g/cm³, greater than or equal to 3.0 g/cm³, or even greater than or equal to 3.2 g/cm³. In embodiments, the glass composition and the resultant glass article may have a density less than or equal to 4.4 g/cm³, less than or equal to 4.2 g/cm³, less than or equal to 4.0 g/cm³, or even less than or equal to 3.8 g/cm³.

In embodiments, the glass composition and the resultant glass article may have a refractive index greater than or equal to 1.4, greater than or equal to 1.5, or even greater than or equal to 1.6. In embodiments, the glass composition and the resultant glass article may have a refractive index less than or equal to 2.0, less than or equal to 1.9, or even less than or equal to 1.8.

In embodiments, the glass composition and the resultant glass article may have a SOC greater than or equal to 1.6 nm/mm/MPa or even greater than or equal to 1.8 nm/mm/MPa. In embodiments, the glass composition and the resultant glass article may have a SOC less than or equal to 2.5 nm/mm/MPa or less than or equal to 2.3 nm/mm/MPa.

In embodiments, the glass composition and the resultant glass article may have a shear modulus greater than or equal to 30 GPa, greater than or equal to 35 GPa, or even greater than or equal to 40 GPa. In embodiments, the glass composition and the resultant glass article may have a shear modulus less than or equal to 65 GPa, less than or equal to 60 GPa, or even less than or equal to 55 GPa.

In embodiments, the glass composition and the resultant glass article may have a Poisson's ratio greater than or equal to 0.22, greater than or equal to 0.24, or even greater than or equal to 0.26. In embodiments, the glass composition and the resultant glass article may have a Poisson's ratio less than or equal to 0.33, less than or equal to 0.31, or even less than or equal to 0.29.

In embodiments, the glass composition and the resultant glass article may have a CTE greater than or equal to 35×10⁻⁷/° C., greater than or equal to 40×10⁻⁷/° C., or even greater than or equal to 45×10⁻⁷/° C. In embodiments, the glass composition and the resultant glass article may have a CTE less than or equal to 70×10⁻⁷/° C., less than or equal to 65×10⁻⁷/° C., or even less than or equal to 60×10⁻⁷/° C.

In embodiments, the glass composition and the resultant glass article may have a K_{1c} fracture toughness of greater than or equal to 0.7 MPa·m^{1/2}, greater than or equal to 0.8 MPa·m^{1/2}, greater than or equal to 0.9 MPa·m^{1/2}, or even greater than or equal to 1 MPa·m^{1/2}.

In embodiments, the glass composition and the result glass article make have a Vickers hardness greater than or equal to 800 kgf/mm².

In embodiments, the method for forming a glass article may include heat treating the glass composition as described herein at one or more preselected temperatures for one or more preselected times to melt the glass composition and cooling the glass composition. As described herein, the glass compositions may have relatively high liquidus temperatures (e.g., greater than or equal to 1200° C.) that are beyond those suitable for conventional glass manufacturing. In embodiments, manufacturing methods that rapidly quench the glass composition (e.g., cooling rate greater than 50° C./s) to reduce or avoid crystallization may be used to form glass articles from the glass compositions disclosed herein.

In embodiments, the heat treatment for making a glass article may include: (i) heating a glass composition at a rate of 1-100° C./min to a molding temperature; and (ii) and cooling the glass composition from the molding temperature to a formed temperature at a cooling rate greater than 50° C./s, thereby forming the glass article.

“Molding temperature,” as used herein, refers to the temperature of the glass composition when it is poured onto a mold. The molding temperature may be a temperature greater than the liquidus temperature of the glass composition that obtains a crystal-free part. Accordingly, in embodiments, the molding temperature may be greater than or equal to 1200° C., greater than or equal to 1250° C., greater than or equal to 1300° C., greater than or equal to 1350° C., greater than or equal to 1400° C., or even greater than or equal to 1450° C. In embodiments, the molding temperature may be less than or equal to 1700° C., less than or equal to 1650° C., less than or equal to 1600° C., or even less than or equal to 1550° C.

In embodiments, the formed temperature may be greater than or equal to 400° C., greater than or equal to 500° C., greater than or equal to 600° C., or even greater than or equal to 700° C. less than the molding temperature. In embodiments, the formed temperature may be greater than or equal to 750° C., greater than or equal to 800° C., or even greater than or equal to 850° C.

In embodiments, the cooling rate may be greater than 50° C./s, greater than 60° C./s, greater than 70° C./s, greater than 80° C./s, greater than 90° C./s, or even greater than 100° C./s. In embodiments, the glass composition may be cooled for greater than 2 seconds, greater than 3 seconds, greater than 4 seconds, greater than 5 seconds, or even greater than 6 seconds.

Various manufacturing methods may be used to form glass articles from the glass compositions described herein, provided that the method rapidly quenches the glass composition (e.g., cooling rate greater than 50° C./s) to reduce or avoid crystallization. For example, in embodiments, the method may comprise pressing and plastically deforming a gob of the glass composition. Such “gob-pressing methods” are described in U.S. patent application Ser. No. 18/388,235 filed Nov. 9, 2023, which is hereby incorporated herein by reference in its entirety. In such gob-pressing methods, the cooling step may comprise: (i) pouring the glass composition into a mold; (ii) traversing the mold into a press; (iii) pressing the glass composition; and (iv) traversing the mold out of the press.

In embodiments, the glass compositions described herein are ion exchangeable to facilitate strengthening the glass articles made from the glass compositions. In typical ion exchange processes, smaller metal ions in the glass article are replaced or “exchanged” with larger metal ions of the same valence within a layer that is close to the outer surface of the glass article. The replacement of smaller ions with larger ions creates a compressive stress within the layer of the glass article. In embodiments, the metal ions are monovalent metal ions (e.g., Li⁺, Na⁺, K⁺, and the like), and ion exchange is accomplished by immersing the glass article in a bath comprising at least one molten salt of the larger metal ion that is to replace the smaller metal ion in the glass article. Alternatively, other monovalent ions such as Ag⁺, Tl⁺, Cu⁺, and the like may be exchanged for monovalent ions. The ion exchange process or processes that are used to strengthen the glass article may include, but are not limited to, immersion in a single bath or multiple baths of like or different compositions with washing and/or annealing steps between immersions.

Upon exposure to the glass article, the ion exchange solution (e.g., KNO₃ and/or NaNO₃ molten salt bath) may, according to embodiments, be at a temperature greater than or equal to 350° C. and less than or equal to 500° C., greater than or equal to 360° C. and less than or equal to 450° C., greater than or equal to 370° C. and less than or equal to 440° C., greater than or equal to 360° C. and less than or equal to 420° C., greater than or equal to 370° C. and less than or equal to 400° C., greater than or equal to 375° C. and less than or equal to 475° C., greater than or equal to 400° C. and less than or equal to 500° C., greater than or equal to 410° C. and less than or equal to 490° C., greater than or equal to 420° C. and less than or equal to 480° C., greater than or equal to 430° C. and less than or equal to 470° C., or even greater than or equal to 440° C. and less than or equal to 460° C., or any and all sub-ranges between the foregoing values. Alternatively, instead of nitrate salts of potassium and sodium, sulfur-based salts or mixes of nitrate- and sulfur-based salts may be used and the salt bath temperature may be raised, such as is disclosed in U.S. application Ser. No. 18/944,699 filed Nov. 12, 2024, which is hereby incorporated by reference herein in its entirety.

In embodiments, the glass article may be exposed to the ion exchange solution for a duration greater than or equal to 1 hour and less than or equal to 24 hours, greater than or equal to 1 hour and less than or equal to 18 hours, greater than or equal to 1 hour and less than or equal to 12 hours, greater than or equal to 1 hour and less than or equal to 6 hours.

The glass composition and resultant glass article described herein may be used for a variety of applications including, for example, for cover glass or glass backplane applications in consumer or commercial electronic devices including, for example, LCD and LED displays, computer monitors, and automated teller machines (ATMs); for touch screen or touch sensor applications, for portable electronic devices including, for example, mobile telephones, personal media players, watches and tablet computers; for integrated circuit applications including, for example, semiconductor wafers; for photovoltaic applications; for architectural glass applications; for automotive or vehicular glass applications; or for commercial or household appliance applications. In embodiments, a consumer electronic device (e.g., smartphones, tablet computers, watches, personal computers, ultrabooks, televisions, and cameras), an architectural glass, and/or an automotive glass may comprise a glass article as described herein.

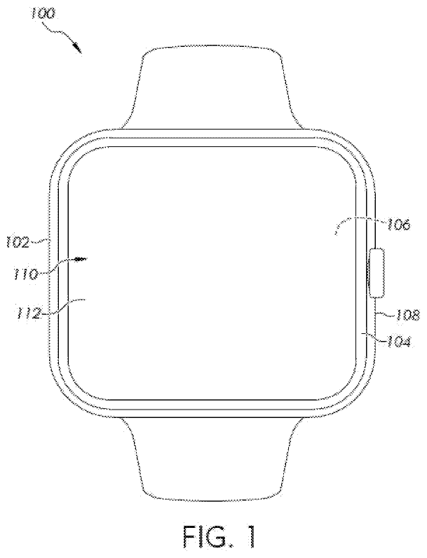

An example electronic device incorporating any of the glass articles disclosed herein is shown in FIG. 1. Specifically, FIG. 1 shows a consumer electronic device 100 including a housing 102 having front 104, back 106, and side surfaces 108; electrical components (not shown) that are at least partially inside or entirely within the housing and including at least a controller, a memory, and a display 110 at or adjacent to the front surface of the housing; and a cover substrate 112 at or over the front surface of the housing such that it is over the display. In embodiments, at least a portion of at least one of the cover substrate 112 and the housing 102 may include any of the glass articles disclosed herein.

### EXAMPLES

In order that various embodiments be more readily understood, reference is made to the following examples, which are intended to illustrate various embodiments of the glass compositions described herein. The following Table show example glass compositions (in terms of mol %) and the respective properties of the glass compositions. Glass articles were formed from example glass compositions Ex. 1 to Ex. 7.

| As analyzed (mol %) | Ex. 1 | Ex. 2 | Ex. 3 | Ex. 4 | Ex. 5 | Ex. 6 | Ex. 7 |
|---|---|---|---|---|---|---|---|
| SiO₂ | 42.304 | 47.352 | 43.967 | 45.901 | 41.346 | 43.866 | 42.776 |
| Al₂O₃ | 25.14 | 22.001 | 24.693 | 22.288 | 24.747 | 21.726 | 24.634 |
| P₂O₅ | 2.084 | 0.013 | 0.014 | 0.013 | 0.013 | 0.013 | 0.013 |
| Li₂O | 14.595 | 14.33 | 14.346 | 14.035 | 14.035 | 15.961 | 16.096 |
| Na₂O | 2.092 | 2.214 | 2.075 | 2.113 | 1.995 | 1.988 | 2.12 |
| MgO | 3.782 | 4.375 | 5.166 | 5.632 | 8.003 | 6.569 | 4.785 |
| CaO | 0.07 | 0.068 | 0.071 | 0.085 | 0.084 | 0.073 | 0.071 |
| Y₂O₃ | 9.927 | 9.73 | 9.661 | 9.925 | 9.769 | 9.794 | 9.497 |
| Fe₂O₃ | 0.006 | 0.006 | 0.007 | 0.006 | 0.008 | 0.007 | 0.006 |
| TiO₂ | | 0.001 | 0.001 | 0.002 | 0.001 | 0.002 | 0.002 |
| Anneal Pt (° C.) | 665 | 656 | 666 | 650 | 660 | 643 | 649 |
| Strain Pt (° C.) | 629 | 618 | 629 | 614 | 622 | 606 | 613 |
| Softening Pt (° C.) | 822 | 814 | 825 | 812 | 818 | 811 | |
| Poissons | 0.226 | 0.256 | 0.261 | 0.263 | 0.266 | 0.259 | 0.263 |
| Shear Modulus (GPa) | 44 | 44 | 45 | 46 | 46 | 44 | 45 |
| Young's Modulus (GPa) | 111 | 111 | 113 | 115 | 116 | 112 | 115 |
| Density (g/cm³) | 3.02 | 3.03 | 3.053 | 3.076 | 3.05 | 3.031 | 3.031 |
| Liquidus Temp, Internal (° C.) | 1480 | 1450 | 1505 | 1530 | 1500 | 1465 | 1515 |
| Refractive index nd | 1.628 | 1.622 | 1.631 | 1.641 | 1.637 | 1.633 | 1.626 |
| SOC (nm/(mm MPa) | | 2.064 | 2.077 | 2.026 | 2.067 | 2.105 | 2.059 |

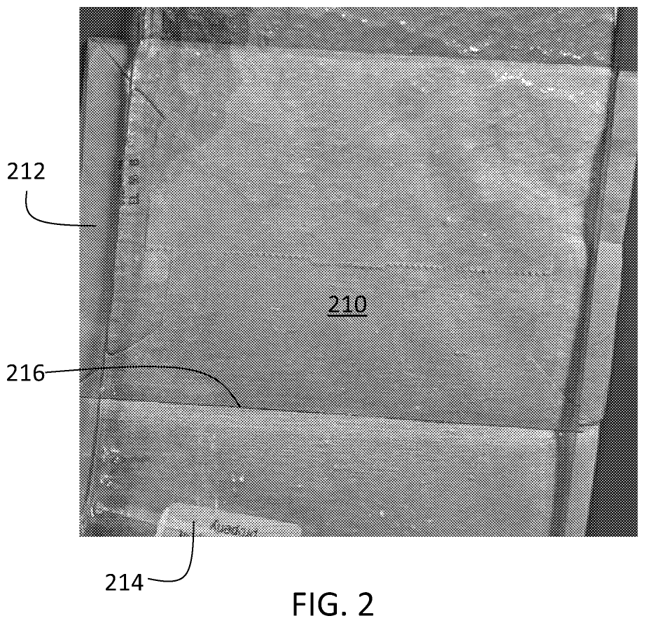

As indicated by the example glass compositions, the glass compositions and the resultant glass articles described herein have a relatively high Young's modulus, and corresponding properties as disclosed above. FIGS. 2-8 show digital images of glass articles formed from Examples 1-7 of the above Table, respectively.

More specifically, FIG. 2 shows a glass article 210 formed from the glass of Example 1 overlaying a paper bag 212 with a sticker 214 beneath the glass article 210. A crease 216 in the paper bag 212 and the sticker 214 are visible through the glass article 210. Glass of Example 1 includes phosphorus pentoxide (P₂O₅), such as at least 0.5 mol % and/or no more than 4 mol %. Example 1 also includes lime (CaO) and small amounts of iron oxide (Fe₂O₃), as may be from contaminants in raw materials, such as tramp.

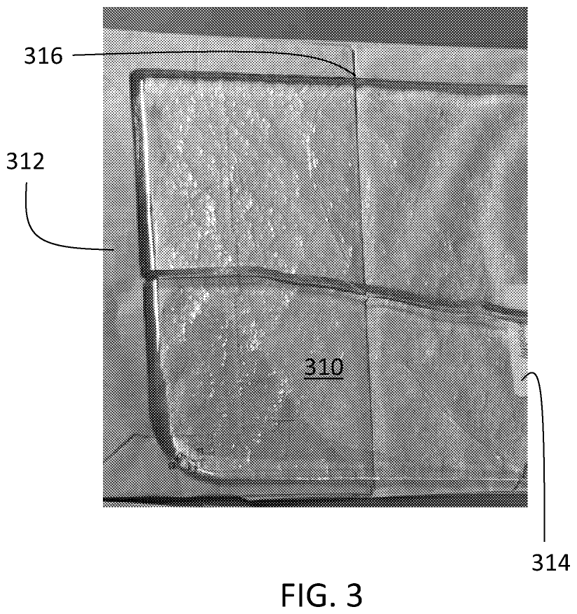

FIG. 3 likewise shows a glass article 310 formed from the glass of Example 2 overlaying a paper bag 312 with a sticker 314 beneath the glass article 310. A crease 316 in the paper bag 312 and the sticker 314 are visible through the glass article 310. Example 2 (and the remaining Examples 3-7) is includes only small amounts of phosphorus pentoxide, iron oxide, and titania (TiO₂), at tramp levels, such as below 0.02 mol %.

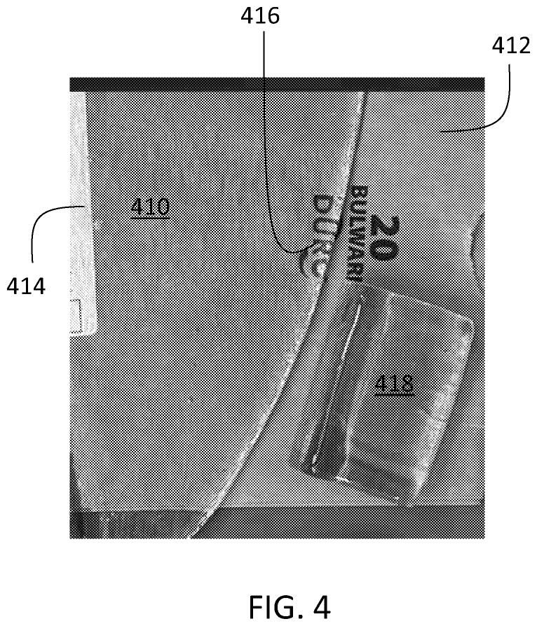

FIG. 4 shows a first glass article 410 formed from the glass of Example 3 overlaying a paper bag 412 with a sticker 414 beneath the first glass article 410. Lettering 416 on the paper bag 412 and the sticker 414 are visible through the first glass article 410. FIG. 4 also shows a second glass article 418 formed from the glass of Example 3 that is thicker than the first glass article 410.

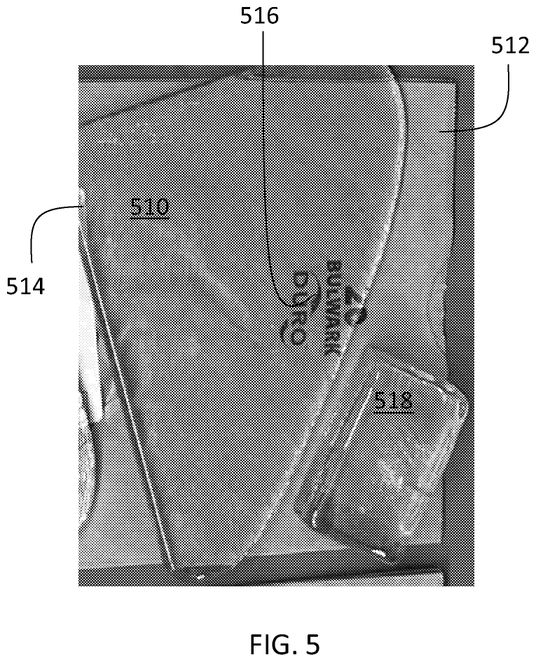

Similarly, FIG. 5 shows a first glass article 510 formed from the glass of Example 4 overlaying a paper bag 512 with a sticker 514 beneath the first glass article 510. Lettering 516 on the paper bag 512 and the sticker 514 are visible through the first glass article 510. FIG. 5 also shows a second glass article 518 formed from the glass of Example 4 that is thicker than the first glass article 510.

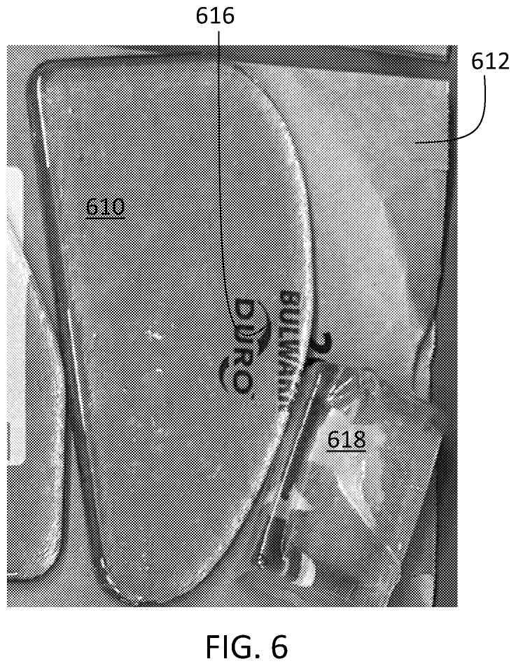

FIG. 6 likewise shows a first glass article 610 formed from the glass of Example 5 overlaying a paper bag 612 beneath the first glass article 610. Lettering 616 on the paper bag 612 is visible through the first glass article 610. FIG. 6 also shows a second glass article 618 formed from the glass of Example 5 that is thicker than the first glass article 610.

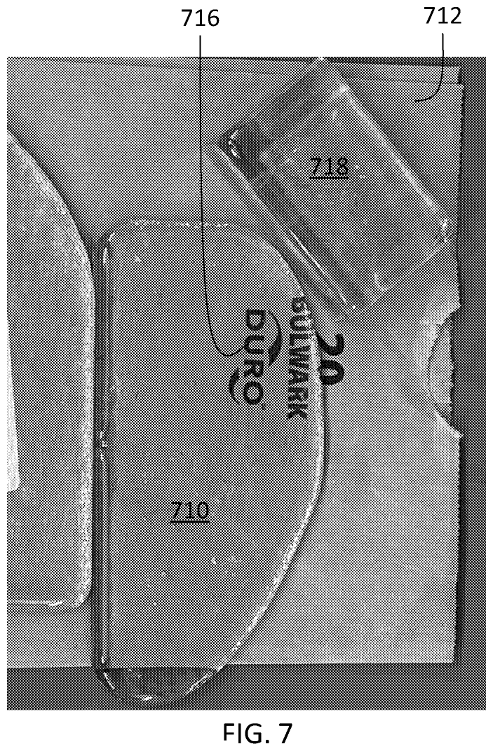

FIG. 7 shows a first glass article 710 formed from the glass of Example 6 overlaying a paper bag 712 beneath the first glass article 710. Lettering 716 on the paper bag 712 is visible through the first glass article 710. FIG. 7 also shows a second glass article 718 formed from the glass of Example 6 that is thicker than the first glass article 710.

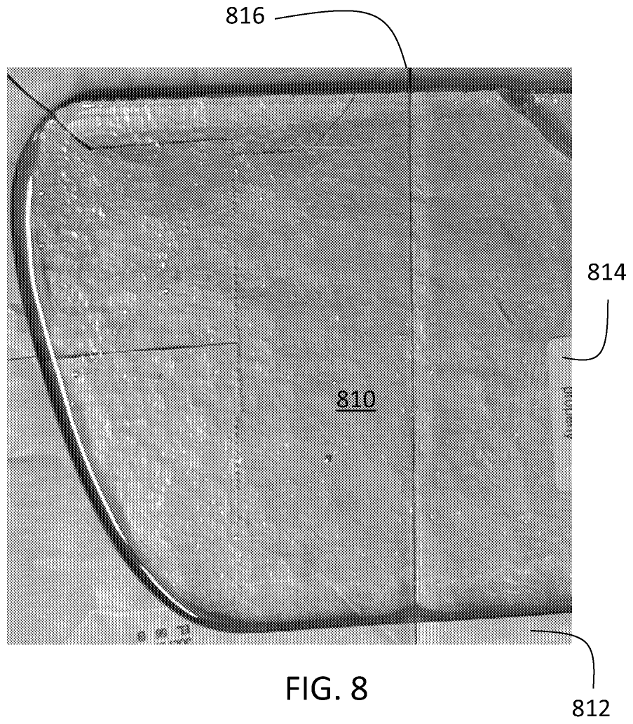

FIG. 8 shows a glass article 810 formed from the glass of Example 7 overlaying a paper bag 812 with a sticker 814 beneath the glass article 810. A crease 816 in the paper bag 812 and the sticker 814 are visible through the glass article 810.

Glasses of Examples 1-7 can be quickly quenched, such as cooled at a rate greater than 50° C./s as disclosed herein, to form articles where the glass is amorphous, meaning that glass of the article is a solid having atoms and molecules lacking the long-range (e.g., greater than 1000 atomic spacings) regularity where solids such as atoms and molecules arranged in a repeating lattice pattern characteristic of crystalline structure. That said, the amorphous glasses may still include inclusions, such as small, unmelted grains of raw materials and gas blisters for example, such as having a cross-sectional dimension greater than 100 nm and/or less than 20 μm. According to an aspect, the glass is formed and quenched to be amorphous such that the glass has fewer than 0.02% by weight crystals therein, however the glass may include some crystals, such as in the form of inclusions, as may be detectable in a laboratory, but where such crystals have a cross-sectional dimension greater than 100 nm and/or less than 20 μm.

Applicants believe that the high elastic moduli of glasses disclosed herein make the glasses highly-suitable for thermal tempering. To temper the glasses in this manner, Applicants heat an article comprising the glasses (e.g., sheet, tube, vial, rod) over 700° C., such as over 800° C., such as over 850° C., such as to a glass transition temperature thereof, such that the glass is in a state of expanded molecular network. Then Applicants rapidly cool the article from surfaces thereof inward. Glass at the surfaces is ‘frozen’ at a higher fictive temperature than glasses interior to the surfaces, corresponding to a more expanded network. Interior to the surfaces, the glass of the article cools more slowly and condenses to a greater degree, draw the surfaces into compression. According to an aspect, the article is thermally tempered such that surfaces thereof experience a compressive stress of at least 10 MPa, at least 50 MPa, at least 100 MPa, such as at least 200 MPa, such as at least 300 MPa, and/or no more than a frangibility limit of the glasses, and/or no more than 5 GPa for example.

According to an aspect and as shown in the Examples, the glasses may be translucent and/or transparent, such as having an average transmittance of at least 10% for light in a wavelength range from 380 nm to 750 nm through a pathlength (e.g., thickness) of a linear dimension (e.g., 0.6 mm, 0.8 mm, 1 mm, 1.4 mm, 2 mm, 3 mm), such as at least 40%, at least 50%, at least 60%, at least 70%, at least 80%, and/or even over 90%. Transmittance in the visible spectrum may be measured with a Lambda 950 UV/Vis/NIR Spectrophotometer manufactured by PerkinElmer Inc. (Waltham, Massachusetts USA). The Lambda 950 apparatus may be fitted with a 150 mm integrating sphere. Data may then be collected using an open beam baseline and a Spectralon® reference reflectance disk. For total transmittance, the sample may be fixed at the integrating sphere entry point. The term “average transmittance,” as used herein with respect to the visible spectrum, refers to the average of total transmittance measurements made within a given wavelength range with each whole numbered wavelengths weighted equally. As used herein, the “average transmittance” with respect to the visible spectrum is over the wavelength range from 380 nm to 750 nm (inclusive of endpoints). Unless otherwise specified, the average transmittance is indicated for light pathlength (e.g., article thickness) of 0.6 mm through glass of the same composition.

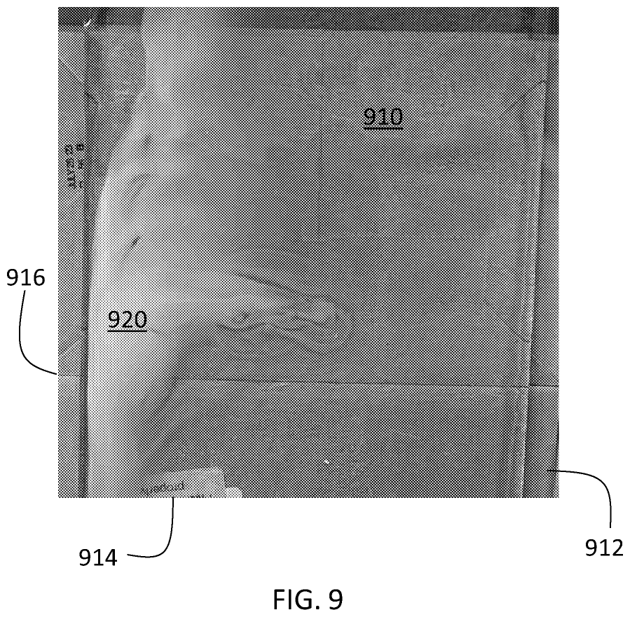

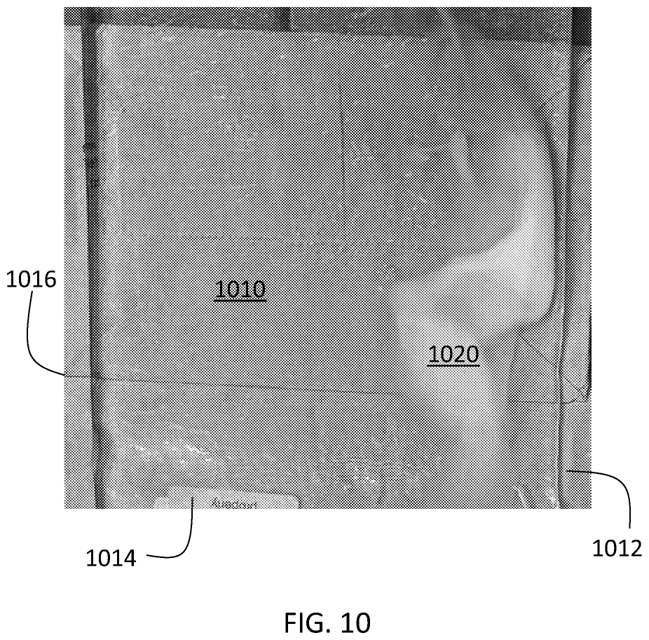

While the glasses of FIGS. 2-8 forming the articles thereof from Examples 1-7 have been formed using the technology disclosed herein to produce translucent, amorphous articles, other glasses of compositions disclosed herein or otherwise formed may devitrify, forming a crystal phase therein, which may reduce transparency of the glasses. See generally FIGS. 9-10.

For example, Applicants also created glass of Example 8 (see FIG. 9) consisting of 37.971 mol % silica, 24.981 mol % alumina, 1.998 mol % phosphorus pentoxide (empirical formula P₂O₅), 13.986 mol % lithia, 1.993 mol % soda, 8.994 mol % magnesia, 0.071 mol % lime (CaO), 9.992 mol % yttria, 0.008 mol % iron oxide (Fe₂O₃), and 0.006 mol % titania (TiO₂); and Example 9 (see FIG. 10) consisting of 37.977 mol % silica, 24.985 mol % alumina, 1.999 mol % phosphorus pentoxide, 15.987 mol % lithia, 1.993 mol % soda, 6.997 mol % magnesia, 0.057 mol % lime, 9.993 mol % yttria, 0.007 mol % iron oxide, and 0.006 mol % titania.

FIG. 9 shows a glass article 910 formed from the glass of Example 8 overlaying a paper bag 912 with a sticker 914 beneath the glass article 910. A crease 916 in the paper bag 912 and the sticker 914 are visible through a portion of the glass article 910. However, the glass of the glass article 910 includes a portion 920 that is not amorphous and has devitrified. The crease 916 is not visible through the portion 920.

While the glass article 910 includes only the portion 920 that has devitrified, other glass articles with compositions disclosed herein may have a crystalline phase fully throughout the respective article, such as where the crystally phase is greater than 0.1% by weight of the glass of the respective article, such a as greater than 1%, 2%, 5%, but less than the 99%, such as less than 90%, where the remaining portion of the respective article is a (residual) glass phase forming a matrix between crystals of the crystalline phase. Amorphous glass, such as those shown in FIGS. 2-8, are free of crystals and/or have fewer than 0.02 wt % crystals for example.

Similarly FIG. 10 shows a glass article 1010 formed from the glass of Example 9 overlaying a paper bag 1012 with a sticker 1014 beneath the glass article 1010. A crease 1016 in the paper bag 1012 and the sticker 1014 are visible through a portion of the glass article 1010. However, the glass of the glass article 1010 includes a portion 1020 that is not amorphous and has devitrified. The crease 1016 is not visible through the portion 1020.

The glasses of Examples 8-9 has devitrified, as shown by portions 920 and 1020 in FIGS. 9-10 respectively, which may in part be due to differences in composition between the glasses of Examples 8-9 and those of Examples 1-7. While Example 1 and 8-9 each include phosphorus pentoxide, as disclosed, the glasses of Examples 8-9 also have greater amounts of magnesia and lesser amounts of silica. While glass Examples 5 and 8-9 have greater amounts of magnesia than glass of Examples 1~4 and 6-7, the glass of Examples 8-9 includes phosphorus pentoxide and lesser amounts of silica. With more magnesia (e.g., >6.6 mol %), less silica (e.g., <40 mol %), and inclusion of phosphorus pentoxide (e.g., >1 mol %) for example, glasses as disclosed herein may be more susceptible to devitrification. Applicants contemplate that such glasses may still be formed to be amorphous (e.g., fewer than 0.02 wt % crystals) by cooling the glasses at faster, such as 10° C./s greater than 50° C./s or faster. Alternatively, greater haze and light diffusion provided by a crystalline phase may be useful for lighting, for example, and glasses of compositions disclosed herein may be formed to purposely include a crystal phase.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A glass, in terms of mol % of representative oxides, comprising:
silica (SiO₂) in an amount greater than 30 mol % and less than 50 mol %;
alumina (Al₂O₃) in an amount greater than 15 mol % and less than 40 mol %;
magnesia (MgO) in an amount greater than 0.02 mol % and less than 20 mol %;
lithia (Li₂O) in an amount greater than 7 mol % and less than 25 mol %;
soda (Na₂O) in an amount greater than 0.02 mol % and less than 4 mol %; and
yttria (Y₂O₃) in an amount greater than 4 mol % and less than 20 mol %;
wherein the glass is amorphous such that the glass has fewer than 0.02 wt % crystals therein.

2. The glass of claim 1, wherein the amount of yttria is greater than 8 mol %.

3. The glass of claim 1, wherein the amount of silicate is greater than 40 mol %.

4. The glass of claim 1, wherein the amount of lithia is greater than 10 mol %.

5. The glass of claim 1, further comprising an amount of zirconia (ZrO₂) less than 2 mol %.

6. A method of making an article with glass of claim 1, comprising cooling the glass from a molten state to a temperature below a softening point thereof at an average rate of at least 50° C./s.

7. A sheet of the glass of claim 1 having a thickness less than 2 mm.

8. A glass, in terms of mol % of representative oxides, comprising:
silica in an amount greater than 30 mol % and less than 50 mol %;
alumina in an amount greater than 15 mol % and less than 40 mol %;
magnesia in an amount greater than 0.02 mol % and less than 20 mol %;
lithia in an amount greater than 7 mol % and less than 25 mol %;
soda in an amount greater than 0.02 mol % and less than 10 mol %; and
yttria in an amount greater than 9 mol % and less than 20 mol % %;
wherein the glass is amorphous such that the glass has fewer than 0.02 wt % crystals therein.

9. The glass of claim 8, wherein the amount of soda is less than 5 mol %.

10. The glass of claim 8, wherein the amount of silicate is greater than 40 mol %.

11. The glass of claim 8, wherein the amount of lithia is greater than 10 mol %.

12. The glass of claim 8, further comprising an amount of zirconia less than 2 mol %.

13. A method of making an article with glass of claim 8, comprising cooling the glass from a molten state to a temperature below a softening point thereof at an average rate of at least 50° C./s.

14. A sheet of the glass of claim 8 having a thickness less than 2 mm.

15. A glass, in terms of mol % of representative oxides, comprising:
silica in an amount greater than 38 mol % and less than 50 mol %;
alumina in an amount greater than 15 mol % and less than 30 mol %;
magnesia in an amount greater than 0.02 mol % and less than 10 mol %;
lithia in an amount greater than 7 mol % and less than 20 mol %;
soda in an amount greater than 0.02 mol % and less than 4 mol %; and
yttria in an amount greater than 9 mol % and less than 20 mol % %;
wherein the glass is amorphous such that the glass has fewer than 0.02 wt % crystals therein.

16. The glass of claim 15, wherein the amount of silicate is greater than 40 mol %.

17. The glass of claim 15, wherein the amount of lithia is greater than 10 mol %.

18. The glass of claim 15, further comprising an amount of zirconia less than 2 mol %.

19. A method of making an article with glass of claim 15, comprising cooling the glass from a molten state to a temperature below a softening point thereof at an average rate of at least 50° C./s.

20. A sheet of the glass of claim 15 having a thickness less than 2 mm.
